(19) United States
(12) Patent Application Publication
(10) Pub. No.: US 2023/0000115 A1
(43) Pub. Date: Jan. 5, 2023

(54) PARTICULATE PRODUCTS AND METHOD FOR PRODUCTION THEREOF

(71) Applicant: SYMRISE AG, Holzminden (DE)

(72) Inventors: Jenny WEISSBRODT, Holzminden (DE); Alexander DIRING, Holzminden (DE); Christopher SABATER, Holzminden (DE)

(21) Appl. No.: 17/778,041

(22) PCT Filed: Nov. 25, 2020
(86) PCT No.: PCT/EP2020/083317

§ 371 Date: May 19, 2022

(30) Foreign Application Priority Data
Nov. 27, 2019 (EP) PCT/EP2019/082733

(51) Int. Cl. A23L 3/46; A23L 27/12; A23L 27/00

(52) U.S. Cl. CPC A23L 3/46; A23L 27/13; A23L 27/72

(57) ABSTRACT

The present invention relates to a process for the production of an agglomerated particulate product containing one or more flavorant(s) and/or odorant(s). By spraying with certain binders, the storage stability of the particulate product is significantly improved, and the flavorant(s) and/or odorant(s) are protected, in particular, from oxidation. The present invention also relates to particulate products containing one or more flavorant(s) and/or odorant(s), preferably produced by a process according to the invention, and to the use of certain substances for improving the storage stability of particulate products containing one or more flavorant(s) and/or odorant(s).

The present invention relates to a process for the production of an agglomerated particulate product containing one or more flavorant(s) and/or odorant(s). By spraying with certain binders, the storage stability of the particulate product is significantly improved, and the flavorant(s) and/or odorant(s) is/are protected, in particular, from oxidation. The present invention also relates to particulate products containing one or more flavorant(s) and/or odorant(s), preferably prepared by a process according to the invention, and to the use of certain substances for improving the storage stability of particulate products containing one or more flavorant(s) and/or odorant(s).

The production of particles with active ingredients is of great importance for applications in the food and beverage sector as well as in the pharmaceutical industry. For example, instant products are usually in the form of dry powder, and aroma particles are used in tea bags or seasoning mixtures. But a particulate form can also be advantageous for active ingredient processing in pharmaceuticals. Depending on the application, it is usually necessary to provide particles of a certain size that form a flowable powder that does not clump together even during prolonged storage and also does not have a tendency to abrasion and dust formation. In addition, the active ingredients should be incorporated into the particles in such a way that they do not decompose and are not released before the end application.

EP0705062B1 relates to a process for producing agglomerated powder of a dairy product, e.g. baby food, wherein a concentrated liquid is first atomized and agglomerated in a drying chamber. The agglomerated particles are then taken up into an internal fluidized bed and finally transferred to an external fluidized bed. The powder thus obtained is divided by returning one part to the drying chamber, while water is atomized over the other part to further agglomerate the product.

GB 1167692A describes a process in which particles in a fluidized bed are sprayed with an agglomerating agent which wets the particles and thereby causes them to adhere to one another. The process can be applied in particular to foodstuffs such as sugar, flour, milk powder or starch, and water, sugar solutions or condensed milk are used as agglomerating agents, for example.

AU2007336516B2 discloses a process for the production of agglomerates by fluidized spray drying, whereby larger particles are separated and dust that has not yet been agglomerated is returned to the drying chamber by an air stream for further agglomeration. According to AU2007336516B2, the process is advantageously used for the preparation of drugs containing poorly soluble active ingredients. For example, the active ingredient is spray-dried together with a polymer as a carrier.

Aroma substances are used in particle form in numerous foodstuffs and semi-luxury foods. In the production of such aroma particles, certain requirements usually have to be met in terms of size distribution, as well as mechanical stability of the particles and storage stability. In particular, it is desirable to achieve the highest possible loading of the particles with aroma while at the same time ensuring that the aroma is incorporated into the particles in such a way that it is not released prematurely or decomposes or volatilizes before final application. Flavorants and odorants are also often particularly sensitive to oxidation by atmospheric oxygen, which contributes to severely limited storage stability. Improvements are therefore needed in known manufacturing processes and in the selection of materials used.

EP1064856B1 describes a process for the production of microcapsules containing active ingredients, such as flavorants, in a matrix. The process comprises several steps, wherein the active ingredients are first spray-dried in an emulsion or suspension with at least one low molecular weight carbohydrate or polyalcohol and a film-forming component, and then transferred to a fluidized bed and further dried.

From EP3117720A1 a process is known in which powdery particles of a certain minimum size are produced. An apparatus used in the process according to EP3117720A1 is shown in FIG. 1. The method comprises the steps
(i) Producing powdery particles by spray drying, in a spray drying agglomeration apparatus having a spray drying section (A) in the upper part of a chamber for drying feed liquid sprayed from a feed liquid atomizer (Z1),
(ii) spraying the powdery particles with a binder liquid, in an integrated fluidized bed (B) in the spray drying agglomeration apparatus, which is located in the lower part of a chamber in which the powder from the spray drying section of step (i) is sprayed with a binder liquid by means of nozzle or atomizer structure (Z2) attached to the bottom of the fluidized bed (B),

whereby the particles are permanently kept in motion and swirled up during production.

The process described in EP3117720A1 can be used for the production of aroma particles. In the examples of EP3117720A1, particles produced by the method were stored in a climatic chamber for a period of 144 h and the weight increase of the particles due to hygroscopicity was determined. However, EP3117720A1 does not deal with the storage stability of the aroma particles and in particular the stability of the aroma over several months.

It was an object of the present invention to provide aroma particles and processes for their production, whereby the aroma particles should be suitable for use in foodstuffs and semi-luxury foods. In particular, the particles should have a suitable size, be stable against abrasion and have a low dust value as well as good flowability, i. e. not easily clump together.

Furthermore, it was an object of the present invention to ensure that the aroma particles can be produced by an efficient process and have a high storage stability, preferably over several months to years. In particular, the aroma substances should not be released prematurely and should be protected from oxidation.

The above objects are fulfilled by a process for the production of a particulate product containing one or more flavorant(s) and/or odorant(s), comprising:
(i) Producing particles comprising or consisting of one or more flavorant(s) and/or odorant(s) and one or more carrier(s) by spray drying in a drying chamber of a spray drying apparatus,
(ii) spraying the particles with one or more binder(s) selected from the group consisting of mono- or polysaccharides with reducing groups and sugar alcohols or mixtures thereof, in a fluidized bed which is integrated into the drying chamber, wherein the binder(s) is/are used in total in a concentration of 10 to 30 vol %, preferably 10 to 20 vol %, in aqueous solution,

wherein steps (i) and (ii) take place simultaneously and the particles are permanently kept in motion and agglomerated in the drying chamber, and

wherein the aqueous solution of the binder(s) does/do not contain any flavorants and/or odorants.

Preferably, the process described above is a continuous process in which agglomerates that have reached a certain size are continuously removed from the drying chamber without interrupting the process.

The particles are permanently kept in motion and agitated and/or circulated in the drying chamber. This ensures that smaller particles and dust are continuously wetted with binder and are then very likely to collide with other particles and agglomerate further. Individual particles coated with binder are not generated in the process due to the frequent collision of particles wetted with binder, but loose agglomerates with a porous structure are formed. Advantageously, the process according to the invention can be carried out in a spray drying chamber with an integrated fluidized bed without the need for transfer to another device. Ways of separating such particles agglomerated to the desired size, as well as effective wetting with binder and circulation of the particles are described in EP3117720A1. Preferably, the process according to the invention is carried out in a spray drying agglomeration apparatus as disclosed in EP3117720A1.

In the context of the present invention, a particulate product means any product consisting of particles. In particular, a particulate product is a granule or a powder. A particulate product may also comprise or consist of agglomerated particles.

In the context of the present invention, it has been found that the selection and composition of the binder plays a decisive role in stabilizing the flavorant(s) and/or odorant(s) in the agglomerated particles. When the binder is used in concentrations of 10 to 30%, preferably 10 to 20%, particularly good results are obtained. Here, the concentration of the binder determines the drying rate of the binder on the surface of the particles to be agglomerated. The choice of binder can also control how strongly the particles “stick together” in the process. The higher the molecular weight of the binder, the slower it dries; if it is then also used in too high a concentration, the fluidized bed can collapse because the particles stick together so quickly or strongly that the air flow present can no longer fluidize and dry them. In addition, it has been shown that the choice of binder has a major influence on the stability and storage stability of the aroma particles. By using the binders of the invention, flowable, non-cohesive, agglomerated particles with high bulk densities and low dust values can be produced. Mono- or polysaccharides and sugar alcohols are particularly suitable, and it is especially advantageous to use substances or mixtures containing reducing groups, since these effectively protect the flavorant(s) and/or odorant(s) from oxidation. This can significantly improve the storage stability of the aroma particles.

The binder liquid used in step (ii) is prepared at about 10 to 30% and the feed amount is calculated on the feed amount of the spray emulsion used in step (i). For example, for every 100 liters of spray emulsion, about 10 l of binder liquid is fed, or in terms of solids: for every 50 kg of solids from the spray emulsion, about 1 kg of binder dry mass is sprayed.

Monosaccharides or polysaccharides include mono-, di-, oligo- and polysaccharides. The monosaccharides and polysaccharides to be used according to the invention contain reducing groups, i. e. free aldehyde groups with reducing properties. In particular, the monosaccharides or polysaccharides with reducing groups or the mixtures thereof have a dextrose equivalent of at least 8, preferably at least 12, particularly preferably at least 18.

A process as described above is preferred, in which the binder(s) is/are selected from the group consisting of sugar alcohols, in particular mannitol, mono-, di- and oligosaccharides with reducing groups, or mixtures containing or consisting of mono-, di- and/or oligosaccharides with reducing groups, in particular glucose, mannose, galactose, maltose, lactose, cellobiose and maltodextrin, and polysaccharides with reducing groups, preferably vegetable gums, in particular gum arabic, traganth, gum ghatti, agar, carrageenan, guar flour and carubin.

The mono-, di- and oligosaccharides with reducing groups or the mixtures containing or consisting of mono-, di- and/or oligosaccharides with reducing groups preferably have a dextrose equivalent of at least 8, preferably at least 12, particularly preferably at least 18.

In particular, a combination of vegetable gum and modified starch as a binder is also according to the invention.

With the preferred binders mentioned, particularly stable particles can be obtained in which the odorant(s) and/or flavorant(s) are not prematurely released or decomposed even after longer storage time. Surprisingly, it has been found that reducing groups in the binder in particular provide effective oxidation protection for the flavorant(s) or odorant(s), even though the binder was initially used only for agglomeration and does not completely cover or seal the particles.

Further preferred is a process as described above in which the flavorant(s) and/or odorant(s) is/are selected from the group consisting of fruit aromas, especially citrus aromas, meat, vegetable and spice aromas, and meat, vegetable and spice extracts. Specific flavorant(s) and/or odorant(s) are described below.

Citrus aromas are particularly sensitive to oxidation and are efficiently protected from oxidation by the aforementioned binders.

Also preferred is a process as described above in which the carrier(s) is/are selected from the group consisting of maltodextrins, dextrins, starches, flours and fibrous materials.

Fibrous materials are insoluble dietary fibers from the group of celluloses, modified celluloses, cereal fibers (e. g. wheat or oats), fruit and vegetable fibers (e. g. apple, carrot, potato, pea or bamboo). Preferably, the fibrous materials have typical particle sizes of 10-500 μm.

Preferred according to the invention is a process as described above, wherein in step i) an emulsion comprising one or more flavorant(s) and/or odorant(s), one or more carrier(s) and at least one emulsifier is sprayed, preferably wherein the flavorant(s) and/or odorant(s) is/are used in a ratio of 2:1 to 1:2, preferably 1.5:1 to 1:1.5 to the at least one emulsifier and/or wherein the flavorant(s) and/or odorant(s) is/are used in a ratio of 1:2 to 1:4, preferably 1:2.5 to 1:3.5 to the carrier(s).

Further preferred is a process as described above in which the at least one emulsifier is selected from the group consisting of gum arabic, modified starches, proteins, in particular vegetable proteins, native or modified pectins and soluble fractions of soy polysaccharides.

A (spray) emulsion as used in step (i) preferably comprises 10 to 30% by weight, preferably 15 to 25% by weight flavorants and/or odorants, 10 to 30t % by weight, preferably 15 to 25% by weight emulsifier and 40 to 80t % by weight, preferably 50 to 70% by weight carrier. These substances are adjusted to a sufficient viscosity with water. The amount of water used for this purpose is approximately equal to the weight of the previously mentioned components or somewhat less.

Also preferred according to the invention is a process in which the emulsion from step (i) is used in a volume ratio of 5:1 to 15:1, preferably 8:1 to 12:1 to the binder solution from step (ii) and/or wherein the solids in the emulsion from step (i) are used in a weight ratio of 30:1 to 70:1, preferably 40:1 to 60:1 to the solids in the binder solution from step (ii).

The present invention also relates to a particulate product, preferably produced or producible by a process as described above, wherein the product consists of particles comprising or consisting of a flavorant and/or odorant and one or more carrier(s) agglomerated with a binder, wherein the agglomerated particles have a porous structure and wherein the binder(s) is/are selected from the group consisting of monosaccharides or polysaccharides with reducing groups and sugar alcohols or mixtures thereof, and wherein the binder(s) does/do not contain a flavorant and/or odorant.

In particular, the monosaccharides or polysaccharides with reducing groups or the mixtures thereof have a dextrose equivalent of at least 8, preferably at least 12, more preferably at least 18.

The product according to the invention is a loose agglomerate of flavorant and/or odorant particles. The binder thereby covers the surface of the particles only incompletely. In particular, the product according to the invention differs from individual coated particles having an “onion structure” in which there is a core that is completely and uniformly covered with one of several layers of binder. Rather, the product of the invention has a “grape structure” in which individual particles are bonded together by the binder. The product has a porous structure and is therefore readily and rapidly dispersible or soluble in water, which is particularly advantageous for use in instant products.

Since the binder itself does not contain any flavorants and/or odorants, the flavorants and/or odorants are not evenly distributed over the agglomerate and are hardly present on the surface. As a result, they are effectively protected from oxidation by the binder. This is remarkable in that the binder does not form a closed layer on the surface of the particles, but merely glues them together. Surprisingly, however, it appears that the presence of reducing groups on the surface is sufficient to protect the flavorants and/or odorants from oxidation.

FIG. 2 shows spray-dried particles with lemon flavoring that have not been agglomerated. FIG. 3 shows the same spray-dried particles agglomerated with water. Although a structure similar to that of the products according to the invention (FIG. 4, agglomerated with gum arabic and FIG. 5, agglomerated with maltodextrin) has been formed here, no protection against oxidation is achieved by the water.

Preferred is a particulate product as described above, wherein the binder(s) is/are selected from the group consisting of sugar alcohols, in particular mannitol, mono-, di- and oligosaccharides with reducing groups or mixtures containing or consisting of mono-, di- and/or oligosaccharides with reducing groups, in particular glucose, mannose, galactose, maltose, lactose, cellobiose, and maltodextrin, and polysaccharides with reducing groups, preferably vegetable gums, in particular gum arabic, traganth, gum ghatti, agar, carrageenan, guar flour and carubin.

The mono-, di- and oligosaccharides with reducing groups or the mixtures containing or consisting of mono-, di- and/or oligosaccharides with reducing groups preferably have a dextrose equivalent of at least 8, preferably at least 12, particularly preferably at least 18.

Further preferred is a particulate article as described above comprising or consisting of.
2 to 35% by weight, preferably 15 to 25% by weight of flavorant(s) and/or odorant(s), and
65 to 98% by weight carrier(s), binder(s) and emulsifier,

wherein, in the case that the binder, or one, more or all of the binder(s), is/are not the same as the carrier(s) and/or the emulsifier, the particulate product comprises from 1 to 10% by weight, preferably from 5 to 8% by weight, of binder, in each case based on the total weight of the product.

The product according to the invention is preferably produced by a process as described above. In this process, it is possible that the carrier(s) and/or emulsifier used in step (i) are or comprise the same substances as the binders used in step (ii). The particles produced therefore comprise a weight percentage of 65 to 89% corresponding to the sum of carrier(s), emulsifier and binder(s). If the carrier(s) and emulsifier used in step (i) are different substances than the binders used in step (ii), the binder(s) will be present in a weight percentage of 1 to 10% of the particles.

Particularly preferred is a particulate product as described above, wherein the carrier(s) is/are selected from the group consisting of maltodextrins, dextrins, starches, flours and fibrous materials and/or wherein the emulsifier is selected from the group consisting of gum arabic, modified starches, proteins, in particular vegetable proteins, native or modified pectins and soluble fractions of soy polysaccharides.

Particularly preferred is a particulate product as described above, produced or producible by a process as described above.

In a preferred embodiment, the agglomerated particles of the article have a D50 value of 100 to 600 μm, preferably 200 to 500 μm, more preferably 300 to 400 μm.

The particle size and particle size distribution of the product play a role in many applications. For example, the particles should be as uniform in size as possible and no larger agglomerates should stick out.

In another preferred embodiment, the particulate product has a flowability in terms of FFC value of 14 or less, preferably 12 or less.

Particulate products according to the invention with flow values of 14 or less or 12 or less, are non-cohesive and preferably have good solubility. This property is particularly important for powders and particles for use in the food sector, since it has a major influence on the end use and application range. Accordingly, the particles thus obtained lead to improved product quality. Preferably, the particles are in a free-flowing non-dusting form. Such particles are easy to dose, easier to process and can be used in a wide variety of applications.

In another preferred embodiment, the bulk density of the particulate product is at least 300 g/L, preferably at least 400 g/L.

Further preferably, the bulk density of the particulate product is in the range of 200 to 600 g/L, preferably 300 to 500 g/L.

A higher bulk density means that the particles have a stable core and thus a higher stability, especially with regard to abrasion. The choice of binder has a direct influence on the bulk density, since good binders improve the cohesion of the agglomerated particles and thus their stability. Advantageously, the binders used according to the invention are also those which enable bulk densities as indicated above.

Further preferred is a particulate product as described above in which the dust value is 13 or less, preferably 12 or less, more preferably 10 or less.

Particulate products according to the invention with dust values of 13 or less, preferably 12 or less, represent particularly stable agglomerates which can advantageously be filled, stored and transported without causing abrasion and dust formation. Here, too, the correct choice of binder is of decisive importance, and it has been shown that the binders to be used in accordance with the invention meet the necessary requirements to maintain the above dust values.

In another preferred embodiment of the particulate product according to the invention, the odorant(s) and/or flavorant(s) are selected from the group consisting of fruit aromas, in particular citrus aromas, meat, vegetable and spice aromas, and meat, vegetable and spice extracts.

In the particulate products according to the invention, the odorants and/or flavorants contained are stably incorporated and, in particular, protected from oxidation. This significantly improves storage stability and keeps oxidation-sensitive aromas, such as citrus aromas, stable for many months.

The odorants and/or flavorants to be used according to the invention are in particular selected from the group consisting of acetophenone, allyl capronate, alpha-ionone, beta-ionone, anisaldehyde, anisyl acetate, anisyl formate, benzaldehyde, benzothiazole, benzyl acetate, benzyl alcohol, benzyl benzoate, butyl butyrate, butyl capronate, butylidene phthalid, carvone, camphene, caryophyllene, cineole, cinnamyl acetate, citral, citronellol, citronellal, citronellyl acetate, cyclohexyl acetate, cymol, damascon, decalactone, dihydrocoumarin, dimethylanthranilate, dodecalactone, ethoxyethyl acetate, ethyl butyric acid, ethyl butyrate, ethyl caprinate, ethyl capronate, ethyl crotonate, ethyl furaneol, ethyl guaiacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, geranyl acetate, grapefruit aldehyde, methyl dihydro jasmonate (e.g. B. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl capronate, trans-2-hexenyl capronate, cis-3-hexenyl formate, cis-2-hexyl acetate, cis-3-hexyl acetate, trans-2-hexyl acetate, cis-3-hexyl formate, para-hydroxybenzylacetone, isoamyl alcohol, isoamyl isovalerianate, isobutyl butyrate, isobutyraldehyde, isoeugenol methyl ether, isopropyl methylthiazole, lauric acid, leavulinic acid, linalool, linalool oxide, linalyl acetate, menthol, mentho-furan, methyl anthranilate, methyl butanol, methyl butyric acid, 2-methyl butyl acetate, methyl capronate, methyl cinnamate, 5-methylfurfural, 3,2,2-methylcyclopentenolone, 6,5,2-methylheptenone, methyl dihydrojasmonate, methyl jasmonate, 2-methyl methyl butyrate, 2-methyl-2-pentenolic acid, methyl thiobutyrate, 3,1-methylthiohexanol, 3-methylthiohexyl acetate, nerol, nerylacetate, trans,trans-2,4-nonadienal, 2,4-nonadienol, 2,6-nonadienol, 2,4-nonadienol, nootkatone, delta octalactone, gamma octalactone, 2-octanol, 3-octanol, 1,3-octenol, 1-octyl acetate, 3-octyl acetate, palmitic acid, paraldehyde, phellandrene, pentanedione, phenyl ethyl acetate, phenyl ethyl alcohol, phenyl ethyl alcohol, phenyl ethyl isovalerate, piperonal, propionaldehyde, propyl butyrate, pulegone, pulegol, sinensal, sulfurol, terpinene, terpineol, terpinolene, 8,3-thiomenthanone, 4,4,2-thiomethylpentanone, thymol, delta-undecalactone, gamma-undecalactone, valencene, valeric acid, vanillin, acetoin, ethylvanillin, ethylvanillin isobutyrate (=3-ethoxy-4-isobutyryloxybenzaldehyde), 2,5-dimethyl-4-hydroxy-3(2H)-furanone and derivatives thereof (preferably homofuraneol (=2-ethyl-4-hydroxy-5-methyl-3(2H)-furanone), homofuronol (=2-ethyl-5-methyl-4-hydroxy-3(2H)-furanone and 5-ethyl-2-methyl-4-hydroxy-3(2H)-furanone), maltol and maltol derivatives (preferably ethyl maltol), coumarin and coumarin derivatives, gamma-lactones (preferably gamma-undecalactone, gamma-nonalactone, gamma-decalactone), delta-lactones (preferably 4-methyldeltadecalactone, massoilactone, deltadecalactone, tuberolactone), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, iso-amyl acetate, ethyl butyric acid ester, n-butyl butyric acid ester, iso-amyl butyric acid ester, ethyl 3-methyl butyric acid ester, ethyl n-hexanoate, allyl n-hexanoate, n-hexanoic acid n-butyl ester, n-octanoic acid ethyl ester, ethyl 3-methyl-3-phenyl glycidate, ethyl 2-trans-4-cis-decadienoate, 4-(p-hydroxyphenyl)-2-butanone, 1,1-dimethoxy-2,2,5-trimethyl-4-hexane, 2,6-dimethyl-5-heptene-1-al and phenylacetaldehyde, 2-methyl-3-(methylthio)furan, 2-methyl-3-furanthiol, bis(2-methyl-3-furyl)disulfide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-dimethylpyrazine, 2,3-diethyl-5-methylpyrazine, 3-isopropyl-2-methoxypyrazine, 3-isobutyl-2-methoxypyrazine, 2-acetyl pyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol, and stereoisomers, enantiomers, positional isomers, diastereomers, cis/trans isomers and epimers (not explicitly mentioned here) of these substances.

The present invention also relates to a product containing a particulate product as described above, selected from the group consisting of food and beverage products, in particular hot and cold, alcoholic and non-alcoholic beverages, fruit and vegetable juice preparations, instant beverages, meat products, egg products, dairy products, products made from soy protein and other vegetable protein sources, fat- and oil-based products or emulsions thereof, fruit and vegetable preparations, snack foods, baked goods, confectionery, soups, sauces, spices and seasoning blends, instant products, ready meals, semi-finished goods, oral care products, pet food and food supplements.

The particulate products according to the invention are applicable in a variety of different products. Products according to the invention include in particular bakery products, for example bread, dry cookies, cakes, other pastries, confectionery products, for example chocolates, chocolate bar products, other bar products, fruit gums, hard and soft caramels, chewing gum, alcoholic or non-alcoholic beverages, such as coffee, tea, iced tea, wine, wine-based beverages, beer, beer-based beverages, liqueurs, spirits, wine spirits, (carbonated) fruit-based sodas, (carbonated) isotonic beverages, (carbonated) soft drinks, nectars, spritzers, fruit and vegetable juices, fruit or vegetable juice preparations, instant beverages, for example, instant cocoa drinks, instant tea drinks, instant coffee drinks, instant fruit drinks, meat products, for example, ham, fresh sausage or raw sausage preparations, seasoned or marinated fresh or cured meat products, eggs or egg products (dried egg, egg white, egg yolk), cereal products, for example, breakfast cereals, granola bars, pre-cooked ready-to-eat rice products, dairy products, for example, milk drinks, buttermilk drinks, milk ice cream, yogurt, kefir, cream cheese, soft cheese, hard cheese, dried milk powder, whey, whey drinks, butter, buttermilk, partially or wholly hydrolyzed milk protein-containing products, products made from soy protein or other soybean fractions, for example, soy milk and products made from it, fruit drinks containing soy protein, preparations containing soy lecithin, fermented products such as tofu or tempeh or products made therefrom, products made from other vegetable protein sources, for example oat protein drinks, fruit preparations, for example jams, fruit ice cream, fruit sauces, fruit fillings, vegetable preparations (for example, ketchup, sauces, dried vegetables, frozen vegetables, precooked vegetables, canned vegetables, snack foods, for example, baked or fried potato chips or potato dough products, corn-based or peanut-based extrudates, fat- and oil-based products or emulsions thereof, e.g. mayonnaise, tartar sauce, dressings, other ready meals and soups (e.g. dry soups, instant soups, pre-cooked soups, spices, seasoning mixtures and in particular seasonings), which are used, for example, in the snack sector.

The present invention also relates to the use of one or more substances selected from monosaccharides or polysaccharides having reducing groups and sugar alcohols as binders for improving the storage stability of a particulate product containing one or more flavorant(s) and/or odorant(s), in particular for improving the oxidation stability of one or more flavorant(s) and/or odorant(s) in a particulate product as described above, preferably produced or producible by a process as described above.

In particular, the monosaccharides or polysaccharides with reducing groups or the mixtures thereof have a dextrose equivalent of at least 8, preferably at least 12, more preferably at least 18.

Preferred is a use as described above, wherein the substance(s) is/are selected from the group consisting of sugar alcohols, in particular mannitol, mono-, di- and oligosaccharides with reducing groups or mixtures containing or consisting of mono-, di- and/or oligosaccharides with reducing groups, in particular glucose, mannose, galactose, maltose, lactose, cellobiose, and maltodextrin, and polysaccharides with reducing groups, preferably vegetable gums, in particular gum arabic, traganth, gum ghatti, agar, carrageenan, guar flour and carubin.

The mono-, di- and oligosaccharides with reducing groups or the mixtures containing or consisting of mono-, di- and/or oligosaccharides with reducing groups preferably have a dextrose equivalent of at least 8, preferably at least 12, particularly preferably at least 18.

In the use according to the invention, the odorant(s) and/or flavorant(s) is/are preferably selected from the group consisting of fruit aromas, in particular citrus aromas, meat, vegetable and spice aromas, and meat, vegetable and spice extracts.

By using the selected binders according to the invention in the production of particulate products containing one or more flavorant(s) and/or odorant(s), the storage stability of the particulate products is significantly increased. In particular, multiple flavorant(s) and/or odorant(s) are protected from oxidation by atmospheric oxygen and therefore remain stable even when stored for many months until final use.

### BRIEF DESCRIPTION OF THE FIGURES

FIG. 1 shows a spray drying agglomeration apparatus as described in EP3117720. (Z2) is the nozzle or atomizer construction, (H) is the weir (with the cap G) and (B) is the fluidized bed.

FIG. 2 shows spray-dried particles with lemon aroma that have not been agglomerated.

FIG. 3 shows spray-dried particles with lemon aroma agglomerated with water.

FIG. 4 shows spray-dried particles with lemon aroma agglomerated with 10% gum arabic.

FIG. 5 shows spray-dried particles with lemon aroma agglomerated with 30% maltodextrin DE8.

FIG. 6 shows cuvettes in which gum arabic of various origins and modified starch were tested with the Folin-Ciolteau reagent for reducing properties (see Example 3). Cuvettes 1 and 2 contain gum arabic (Seyal lot 32), cuvettes 3 and 4 contain gum arabic (Seyal lot 59), cuvettes 5 and 6 contain gum arabic (Senegal lot 55) and cuvettes 7 and 8 contain modified starch (lot 70).

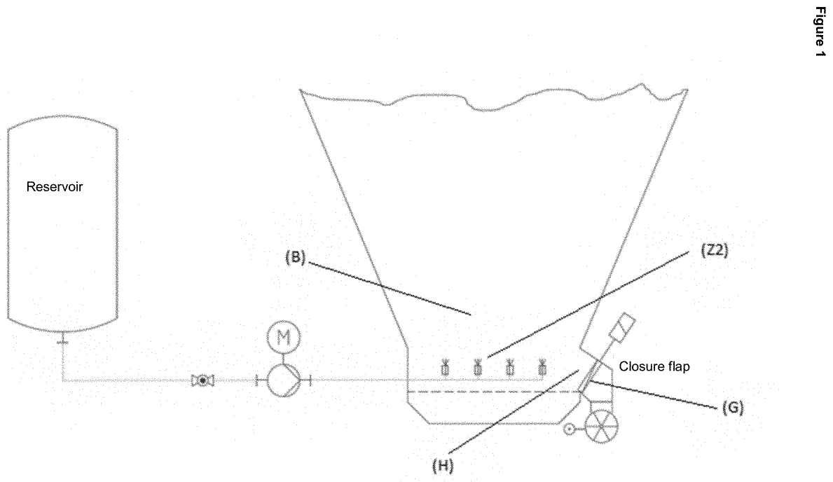

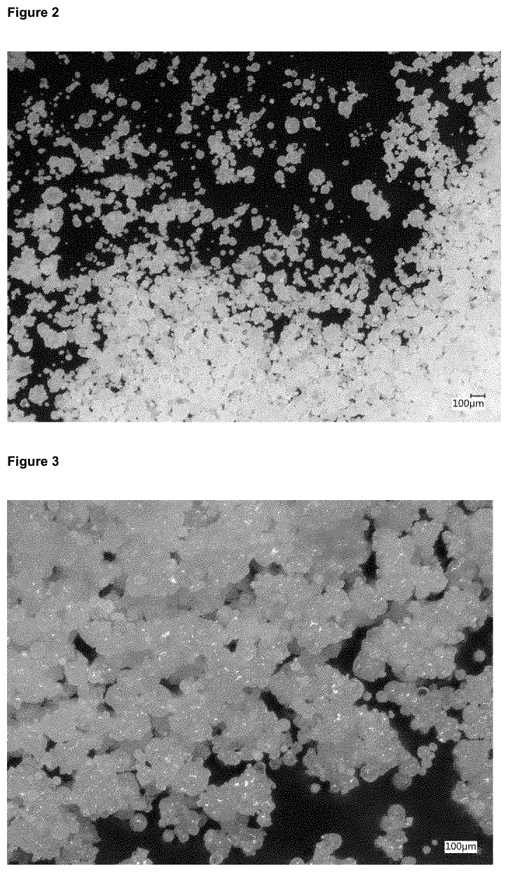

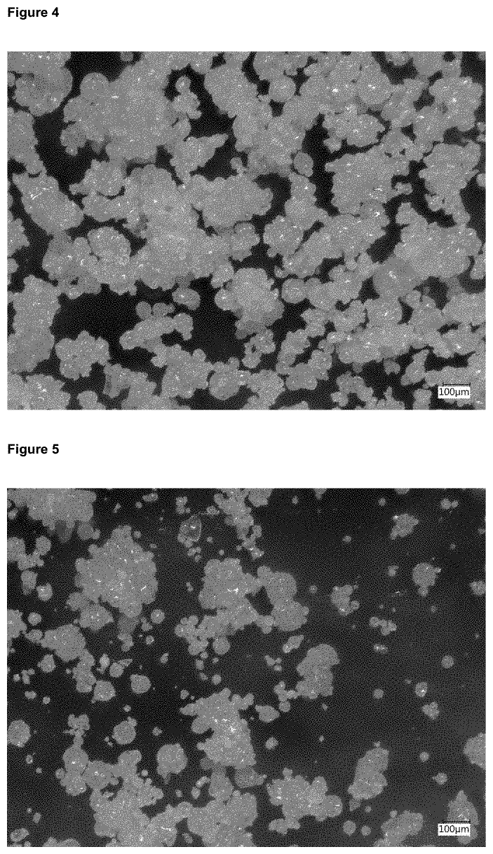

### EXAMPLE 1: SHELF LIFE OF SPRAY PRODUCTS WITH DIFFERENT BINDERS

Standard formulations were selected which have comparatively low shelf lives due to the sensitivity of the aroma, or which have new applications made possible by extending their shelf lives. Since the oxidation sensitivity of citrus aromas is very high, such were used here. The formulation comprises as solids about 20% aroma, 20% emulsifier and 60% carrier. Modified starch or gum arabic was used as emulsifier, and maltodextrins were used as carrier.

The spray products were subjected to agglomeration with different binder liquids at different concentrations. The binder liquids are listed below:

| Original | Lemon |
|---|---|
| Experiment 1 | Maltodextrin DE 17-20 10% |
| Experiment 2 | Maltodextrin DE 17-20 30% |
| Experiment 3 | Maltodextrin DE 8-10 10% |
| Experiment 4 | Maltodextrin DE 8-10 30% |
| Experiment 5 | Gum arabic Senegal 10% |
| Experiment 6 | modified starch 10% |
| Experiment 7 | Mannitol 10% |
| Experiment 8 | Glucose 10% |
| Experiment 9 | Glucose 30% |
| Experiment 10 | Ascorbic acid 10% |
| Experiment 11 | Pectin amidated 2% |
| Experiment 12 | Protein potato 10% |
| Experiment 13 | Protein whey 10% |
| Experiment 14 | Water |
| Experiment 15 | Protein whey 10% acidic, pH 4.5 |

DE 17-20 and DE 8-10 are the dextrose equivalents of the maltodextrin used.

The products were physically characterized and stored for the accelerated storage tests in such a way that the temperature and oxygen partial pressure were increased so that a storage period of one year could be simulated within 12 to 24 hours. Stability was tested after 6 or 12 months of accelerated storage, depending on the shelf life of the liquid flavor. The results are shown in Table 1. Oxipress 12 months and Oxipress 6 months mean that accelerated storage was performed under conditions simulating 12 and 6 months, respectively.

It can be seen from the results that both the material itself and the concentration in which it was sprayed have an influence on the storage stability. The results can be explained by different spreading behavior and the drying properties of the binder liquids. It is surprising, however, that substances which are actually only applied to bond the particles increase the storage stability more than pure surface reduction (simulated by bonding by means of water or steam) does. This is because the substances do not cover the entire surface of the particles, so they cannot seal them. The physical parameters support the results of the stability test.

TABLE 1
Physical properties and results of the storage test

| | | | Particle | | Particle | | | | | | |
|---|---|---|---|---|---|---|---|---|---|---|---|
| | | | size | | size | | FFC | Bulk | | | |
| | | Residual | 0.5 bar | | 3 bar | | (flowability) | density | Dust | Oxipress 12 | Oxipress 6 |
| | | moisture | D50 | D90 | D50 | D90 | FFC | g/L | value | months | months |
| Original | Lemon FDI 10038 AA | 5.00% | 69.3 | 115 | 46.9 | 115 | 10.4 | 424.3 | 15.1 | Failed | Failed |
| Experiment 1 | Maltodextrin 17-20 | 4.40% | 103.2 | 202.9 | 63.7 | 147.1 | 11.7 | 410.2 | 11.5 | Passed | |
| | 104966 10% | | | | | | | | | | |
| Experiment 2 | Maltodextrin 17-20 | 5.07% | 135 | 407.8 | 76.9 | 245 | 11.5 | 419.4 | 9.7 | Passed | |
| | 104966 30% | | | | | | | | | | |
| Experiment 3 | Maltodextrin 8-10 | 5.56% | 128.8 | 316.6 | 77.7 | 207 | 11.6 | 413 | 10 | Passed | |
| | 10% | | | | | | | | | | |
| Experiment 4 | Maltodextrin 8-10 | 5.75% | 113.5 | 235.1 | 69.2 | 164.6 | 11.2 | 439.4 | 11.8 | Failed | Passed |
| | 30% | | | | | | | | | | |
| Experiment 5 | Rubber Senegal 10% | 5.31% | 138.6 | 350.3 | 83.2 | 228.8 | 11.3 | 421.1 | 8.3 | Passed | |
| Experiment 6 | modified starch 10% | 4.61% | 127.4 | 279.2 | 76.3 | 172.9 | 11.2 | 428.6 | 8.1 | Failed | Passed |
| Experiment 7 | Mannitol 10% | 4.19% | 97.9 | 201.1 | 58.5 | 137.5 | 10.4 | 449.6 | 13 | Passed | |
| Experiment 8 | Glucose 107544 10% | 4.78% | 130.8 | 287.8 | 78.4 | 177.1 | 11.4 | 402.6 | 6.7 | Passed | |
| Experiment 9 | Glucose 107544 30% | 4.78% | 126.1 | 495.4 | 73.4 | 194.9 | 12.9 | 408.2 | 7.4 | Passed | |
| Experiment 10 | Ascorbic acid 115414 | 4.01% | 114.4 | 234.2 | 67.2 | 153.6 | 11.5 | 423.5 | 13 | Failed | Passed |
| | 10% | | | | | | | | | | |
| Experiment 11 | Pectin amide 2% | 5.04% | 159 | 403.3 | 97 | 282.3 | 11.3 | 410.7 | 7.7 | Failed | Passed |
| Experiment 12 | Protein potato 10% | 6.20% | 129 | 268.3 | 75.7 | 168.5 | 11.3 | 390.9 | 6.6 | Passed | |
| Experiment 13 | Protein whey 10% | 3.58% | 111.6 | 208.1 | 67.8 | 150 | 12.8 | 396.9 | 6.4 | Failed | Passed |
| Experiment 14 | Water | 4.94% | 119.1 | 258.6 | 71.4 | 166.5 | 11.4 | 391.7 | 9.7 | Passed | |
| Experiment 15 | Protein whey 10% | 4.21% | 124.6 | 268.3 | 71.9 | 163.8 | 13.2 | 377.9 | 5.1 | Passed | |
| | acidic | | | | | | | | | | |

### EXAMPLE 2: TEST FOR DIFFERENCE OF SAMPLES

Because the panelists' descriptions in Example 1 showed strong differences that were not reflected in the “pass, fail” classification, another testing method was used to further tease out the differences.

The stored samples that passed the test in example 1 were tasted against each other according to the DoD (Degree of difference) test procedure. In order not to overload the panelists, the tests had to be divided up, as no more than 5 samples should be compared at the same time, otherwise the risk of panelist fatigue increases.

The task of the panelists was to describe the differences of the samples from the standard (STD) using the given terms. To validate the results, the standard was also tasted as a sample. The fresh sample produced by spray drying without agglomeration was used as the standard. Accordingly, a slight difference means that the stored sample is very close to the fresh product, which indicates a good protective effect of the agglomeration carried out by means of the binder substance. The % values given refer to the proportion of panelists who arrived at the respective assessment.

Tasting was performed with 0.2% of sample on a test solution with sugar and citric acid.

The result shows that the stored samples
Lemon with binder glucose
Lemon with binder maltodextrin EN 17-20
Lemon with binder gum/modified starch

showed a better protective effect than the other binders used for agglomeration.

The protective effect of the glucose and maltodextrin is possibly due to the reducing effect of the sugar. However, it is surprising that a reducing sugar applied to the outside of the particles has such an effect. In the case of the agglomerate, where a mixture of gum arabic and modified starch was used as a binder, it can be assumed that due to the high interfacial activity of these substances, the binder liquid spreads particularly well and thus leads to an even coating of the particles, accompanied by a sealing. In addition, gum arabic has reducing groups, as can be seen from Example 3, and can thus contribute to oxidation stability.

TABLE 2
Tasting without binder and with mannitol and glucose as binders

| | | | | | | | very |
|---|---|---|---|---|---|---|---|
| | No | very | | | Slightly | Sharply | sharply |
| | difference | small | Small | Medium | increasing | increasing | increasing |
| | (STD) | difference | difference | difference | difference | difference | difference |
| 237 | | | 10% | 10% | 40% | 20% | 20% |
| 134 | | 20% | 10% | 20% | 30% | 10% | 10% |
| 456 | | | | | 10% | 30% | 60% |
| 890 | 100% | | | | | | |

Description of the difference:

237: carvony, more bitter than STD, oxidized but still distinctly citric, bitter note, smells
barely citric, smells like toilet stone, slightly bitter, weaker, off, broken.
134: bitter, similar to STD, off, least bad, broken, slightly bitter, slightly citric, slight off
notes, less fresh
456: non-tasting, p-methylacetophenone, bitter, artificial, off, completely oxidized, no
citron, toilet stone, heavily shabby, very bitter
890: STD
STD Lemon SD fresh
237 Lemon Mannitol
134 Lemon Glucose
456 Lemon SD
890 Lemon SD fresh
SD = spray dried (spray dried)

TABLE 3
Tasting without binder and with maltodextrin,
glucose and gum/modified starch as binders

| | | | | | | | very |
|---|---|---|---|---|---|---|---|
| | No | very | | | Slightly | Sharply | sharply |
| | difference | small | Small | Medium | increasing | increasing | increasing |
| | (STD) | difference | difference | difference | difference | difference | difference |
| 569 | | | 20% | 10% | 10% | 60% | |
| 134 | 10% | 20% | 30% | 10% | 30% | | |
| 862 | | | | | | 30% | 70% |
| 709 | 90% | 10% | | | | | |
| 302 | | 20% | 20% | 30% | 30% | | |

Description of the difference:

569: clearly oxidized (2x), slightly bitter (2x), slightly rancid, toilet stone
134: oxidized, very bitter
862: worst sample, totally off (2x), shabby, toilet stone
709: standard
302: best sample, slightly oxidized and bitter, slightly bitter notes
STD Lemon SD fresh
569 Lemon Maltodextrin De 17-20
134 Lemon Glucose
862 Lemon SD
709 Lemon SD fresh
302 Lemon gum/modified starch

TABLE 4
Tasting without binder and with maltodextrin,
whey and gum/modified starch as binder

| | | | | | | | very |
|---|---|---|---|---|---|---|---|
| | No | very | | | Slightly | Sharply | sharply |
| | difference | small | Small | Medium | increasing | increasing | increasing |
| | (STD) | difference | difference | difference | difference | difference | difference |
| 234 | 10% | 10% | 10% | 40% | 10% | 20% | |
| 890 | 50% | 20% | 20% | | | 10% | |
| 410 | | | 10% | 20% | 40% | 30% | — |
| 622 | | | | | | 10% | 90% |
| 398 | 20% | 10% | 20% | 30% | 20% | | |

Description of the difference:

234: bitter (3x), slightly rancid
890: slightly bitter, standard, odor fresh (STD)
410: bitter (2x), artificial, slightly off, toilet stone
622: slightly menthol, strongly bitter, totally um
398: slightly bitter, slightly rancid
STD Lemon SD fresh
234 Lemon Maltodextrin De 17-20
890 Lemon SD fresh
410 Lemon whey
622 Lemon SD
398 Lemon gum/modified starch

### EXAMPLE 3: TEST FOR REDUCING PROPERTIES OF GUM ARABIC AND MODIFIED STARCH

The Folin-Cioltaeu reagent shows a color change from yellow to blue in the presence of reducing groups due to the reaction: Mo(VI)+e->Mo(V).

For each assay, 500 μl of 10% solution of gum arabic was shaken with +750 μl of Folin-Cioltaeu reagent, 750 μm of 8% Na2CO3 solution was added, shaken again, and then stored for 2 h in cuvettes.

Absorbance measurement after 2 h at 765 nm

| | 1. | 2. | Mean |
|---|---|---|---|
| | Measurement | Measurement | value |
| Gum arabic (A Seyal lot 32) | 0.7684 | 0.8863 | 0.83 |
| Gum arabic (Seyal lot 59) | 0.8782 | 0.7754 | 0.83 |
| Gum arabidum (Senegal lot 55) | 0.5964 | 0.555 | 0.58 |
| Modified starch (lot 70) | 0.28 | | 0.28 |

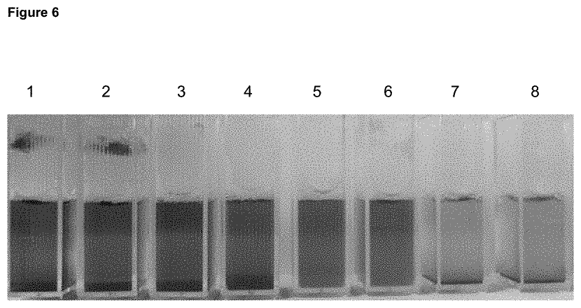

FIG. 6 shows the cuvettes. The darker the coloration of the solution, the stronger the reducing properties of the tested substance. Cuvettes 1 and 2 contain gum arabic (Seyal lot 32), cuvettes 3 and 4 gum arabic (Seyal lot 59), cuvettes 5 and 6 gum arabic (Senegal lot 55) and cuvettes 7 and 8 modified starch (lot 70). Modified starch shows little coloration and therefore contains few reducing groups.

1-15. (canceled)

16. A process for producing a particulate product comprising one or more flavorants and/or odorants, the process comprising:
(i) producing particles comprising or consisting of the one or more flavorants and/or colorants and one or more carriers by spray drying in a drying chamber of a spray drying apparatus;
(ii) spraying the particles in a fluidized bed which is integrated into the drying chamber with an aqueous solution that is free from flavorants and/or colorants but comprises 10 to 30 vol % of one or more binders selected from mono or polysaccharides with reducing groups, sugar alcohols, and a mixture thereof,
wherein (i) and (ii) occur simultaneously and the particles are kept in motion and agglomerated in the drying chamber.

17. The process of claim 16, wherein the one or more binders are selected from glucose, mannose, galactose, maltose, lactose, cellobiose, maltodextrin, gum arabic, traganth, gum ghatti, agar, carrageenan, guar flour, carubin, and combinations thereof.

18. The process of claim 16, wherein the one or more flavorants and/or odorants are selected from fruit aromas, meat aromas, vegetable aromas, spice aromas, meat extracts, vegetable extracts, spice extracts, and a mixture thereof.

19. The process of claim 16, wherein the one or more carriers are chosen from maltodextrins, dextrins, starches, flours, and fibrous materials.

20. The process of claim 16, wherein the particles produced by spray drying in (i) are produced by spray drying an emulsion comprising the one or more flavorants and/or odorants, the one or more carriers, and one or more emulsifiers; and the one or more flavorants and/or odorants and the one or more emulsifiers are in a weight ratio of 2:1 to 1:2 (one or more flavorants and/or odorants: one or more emulsifiers).

21. The process of claim 20, wherein the one or more emulsifiers are selected from gum arabic, modified starches, proteins, native and modified pectins, and soluble fractions of soy polysaccharides.

22. The process of claim 20, wherein the emulsion of (i) and the aqueous solution of (ii) are combined in a volume ratio of 5:1 to 15:1 (emulsion of (i):aqueous solution of (ii)) or solids of the emulsion of (i) and solids of the aqueous solution of (ii) are combined in a weight ratio of 30:1 to 70:1 (solids of (i):solids of (ii)).

23. A particulate product produced by the process of claim 16.

24. The particulate product of claim 23, wherein the one or more binders are selected from glucose, mannose, galactose, maltose, lactose, cellobiose, maltodextrin, gum arabic, traganth, gum ghatti, agar, carrageenan, guar flour, carubin, and combinations thereof.

25. The particulate product of claim 23 comprising or consisting of
2 to 35 wt. % of the one or more flavorants and/or the one or more odorants; and
65 to 98 wt. % of the one or more carriers, the one or more binders, and the one or more emulsifier;
provided that if one or more of the one or more binders are not the same as one or more of the one or more carriers and/or the one or more emulsifiers, the product comprises 1 to 10 wt. % of one or more binders, in each case based on the total weight of the product.

26. The particulate product of claim 23, wherein the one or more carriers are selected from maltodextrins, dextrins, starches, flours, and fibrous materials and the one or more emulsifiers are selected from gum arabic, modified starches, proteins, native or modified pectins, and soluble fractions of soy polysaccharides.

27. The particulate product of claim 23, wherein the one or more odorants and/or flavorants are selected from fruit aromas, meat aromas, vegetable aromas, spice aromas, meat extracts, vegetable extracts, spice extracts, and a mixture thereof.

28. A product comprising a particulate product of claim 23 selected from food and beverage products, fruit and vegetable juice preparations, instant beverages, meat products, egg products, dairy products, products made from soy protein and other vegetable protein sources, fat- and oil-based products or emulsions thereof, fruit and vegetable preparations, snack foods, baked goods, confectionery, soups, sauces, spices and seasoning blends, instant products, ready meals, semi-finished goods, oral care products, pet food, and food supplements.

29. A method for improving oxidation stability one or more flavorants and/or odorants, the method comprising:
(i) producing particles comprising or consisting of the one or more flavorants and/or colorants and one or more carriers by spray drying in a drying chamber of a spray drying apparatus;
(ii) spraying the particles in a fluidized bed which is integrated into the drying chamber with an aqueous solution that is free from flavorants and/or colorants but comprises 10 to 30 vol % of one or more binders selected from mono or polysaccharides with reducing groups, sugar alcohols, and a mixture thereof,
wherein (i) and (ii) occur simultaneously and the particles are kept in motion and agglomerated in the drying chamber.

30. The method of claim 29, wherein the one or more binders are selected from glucose, mannose, galactose, maltose, lactose, cellobiose, maltodextrin, gum arabic, traganth, gum ghatti, agar, carrageenan, guar flour, carubin, and combinations thereof.

31. The method of claim 16, wherein the one or more binders are selected from gum arabic, traganth, gum ghatti, agar, carrageenan, guar flour, carubin, and combinations thereof.

32. The particulate of claim 24, wherein the one or more binders are selected from gum arabic, traganth, gum ghatti, agar, carrageenan, guar flour, carubin, and combinations thereof.
